(19) United States
(12) Patent Application Publication
(10) Pub. No.: US 2015/0115100 A1
(43) Pub. Date: Apr. 30, 2015

(54) STORAGE CABINET FOR A MEANS OF TRANSPORT

(71) Applicant: Airbus Operations GmbH, Hamburg (DE)

(72) Inventors: Ralf SCHLIWA, Hamburg (DE); Sebastian DOERR, Hamburg (DE)

(21) Appl. No.: 14/528,030

(22) Filed: Oct. 30, 2014

(30) Foreign Application Priority Data
Oct. 31, 2013 (DE) 10 2013 112 019.9

(51) Int. Cl. B64D 11/00; B64D 11/04

(52) U.S. Cl. CPC B64D 11/003; B64D 11/04
USPC 244/118.1

(57) ABSTRACT

A stowage closet for storing equipment for a passenger cabin of a means of transport is provided. Furthermore, an aircraft with such stowage closet is provided. The stowage closet comprises a corpus with a height of at least 140 cm and solely one attachment device. The attachment device is arranged in a floor region of the stowage closet for detachably attaching the stowage closet to corresponding floor attachment elements of the passenger cabin beneath a hatrack.

### CROSS-REFERENCE TO RELATED APPLICATIONS

This application claims priority to German Patent Application No. 10 2013 112 019.9, filed Oct. 31, 2013, which is incorporated herein by reference in its entirety.

### TECHNICAL FIELD

The technical field relates to the interior equipment of a means of transport. In particular, the technical field relates to a storage cabinet for storing equipment in a passenger cabin of a means of transport and to an aircraft comprising such a storage cabinet.

### BACKGROUND

The interior equipment in passenger cabins of means of transport is increasingly designed so as to be flexible in order to, for example, take into account customer requirements relating to the interior equipment, or in order to be able to rearrange the interior equipment of the means of transport with little effort in terms of time and labour so that it becomes possible, for example, to react to changed requirements relating to the storage space required.

For example, it can be intended to deploy at times on long-haul flights an aircraft that is predominantly used for short-haul flights. For this purpose it may be advantageous to expand the storage space provided, for example, for a galley module for use in long-haul flights. Furthermore, it may be desirable to be able to carry out any reconfiguration of the interior equipment during a regular stop of the aircraft without this making it necessary to factor in additional waiting time for reconfiguration.

WO 2010 108 775 A2 describes a monument for a cabin of a means of transport, which monument can be used as a storage cabinet in an aircraft. In this arrangement the monument comprises a flexible attachment device that makes it possible to attach the monument relative to the cabin of the means of transport.

WO 2011 080 414 A1 describes a device for optimum cart stowage in a means of transport. In this arrangement the device comprises compartments in which catering trolleys can be received side-by-side.

In addition, other objects, desirable features and characteristics will become apparent from the subsequent summary and detailed description, and the appended claims, taken in conjunction with the accompanying drawings and this background.

### SUMMARY

According to the various teachings of the present disclosure, provided is a storage cabinet for a passenger cabin of a means of transport for storing equipment. The storage cabinet comprises a body of a height of at least 140 cm and exclusively one attachment device. In this arrangement the attachment device is arranged in a floor region of the storage cabinet and is designed for detachably attaching the storage cabinet to corresponding floor attachment elements in the passenger cabin underneath a cabin element. For example, the body comprises a height of between about 140 cm and about 180 cm, for example between about 150 cm and about 180 cm, or between about 160 cm and about 180 cm. The cabin element can, for example, be a hatrack, a storage compartment, a crew rest compartment or some other component of interior equipment in the passenger cabin.

In other words, the storage cabinet can be a storage cabinet that is detachably attached in a passenger cabin of a means of transport, for example an aircraft, a train or a bus, underneath a cabin element, for example a hatrack. In this context, the term “detachably attached” may denote that the storage cabinet may be attached to, and detached from the passenger cabin without disassembly or deformation of said storage cabinet.

According to one embodiment of the present disclosure, the attachment device is designed for undoing the attachment of the storage cabinet from the corresponding floor attachment elements of the passenger cabin by lifting.

This can mean that the storage cabinet and, in one example, the attachment device of the storage cabinet can be designed in such a manner that the storage cabinet can be lifted so that it becomes possible to detach it completely from the floor attachment elements of the passenger cabin. This may require the storage cabinet to comprise a height dimension that makes it possible to lift said storage cabinet without there being a need to disassemble further interior equipment. For example, in this arrangement the passenger cabin and the storage cabinet can be designed in such a manner that the storage cabinet can be lifted by at least about 5 mm, for example by about 7 mm, or for example by about 10 mm, without this necessitating deinstallation of the hatracks under which the storage cabinet is installed.

For easier lifting of the storage cabinet said storage cabinet can comprise a lifting device. For example, handles can be arranged on two opposite sidewalls on the outside of the storage cabinet, which handles may facilitate lifting the storage cabinet for the purpose of undoing the attachment device.

According to one embodiment of the present disclosure, the attachment device comprises at least four attachment elements that are designed for attaching the storage cabinet to the corresponding floor attachment elements in the passenger cabin.

In this arrangement the at least four attachment elements can be arranged in a floor region of the storage cabinet. For example, the attachment elements can be arranged on the inside, i.e. in the interior of the storage cabinet, on a sidewall, and/or on a bottom partition wall of the body. In this arrangement the attachment elements can be designed so as to cooperate with the corresponding floor attachment elements in the passenger cabin. This can, for example, mean that the attachment elements can be designed in such a manner that for attachment of the storage cabinet they can engage the floor attachment elements. In this arrangement, for example, so-called quick-change fasteners can be used that can allow quick installation and deinstallation of the storage cabinet. Such a quick-change fastener can, for example, be a quick-change seat track fitting which, for example, can be designed so that it can be lowered and clicked into the floor attachment elements in the passenger cabin.

Furthermore, the attachment elements can comprise a locking device that makes it possible to detachably affix the storage cabinet to the floor attachment elements. The locking device can, for example, be designed in a lever-like manner so that the attachment elements can be locked and unlocked, for example by activating a lever.

According to one embodiment of the present disclosure, the storage cabinet comprises a top partition wall, wherein a surface of the top partition wall, which surface faces an outside of the storage cabinet, can be used as a storage surface, and wherein on the storage surface a ledge is arranged that projects upwards towards the outside of the storage cabinet, which ledge is designed to delimit the storage surface laterally and towards the rear of the storage cabinet. The storage surface can, for example, be used to temporarily store utility objects, for example documents, journals or newspapers.

The ledge can, for example, be designed to prevent lateral and/or rear sliding or falling of objects placed on the storage surface. To this effect the ledge can, for example, be of a solid design and can be inflexibly arranged on the storage surface. The ledge can, for example, be integrally designed with a sidewall and/or a rear wall of the storage cabinet, or it can be arranged as a separate element on the storage surface. The ledge can also comprise a pivoting element, for example in the form of a hinge, and can be pivotable so that the ledge can, for example, be pivotable towards the storage surface and/or on the outsides towards the sidewalls and the rear wall of the storage cabinet in the direction of the floor region. The ledge can also comprise a sliding element and can be designed to be slidable into a corresponding guide element of the storage cabinet. However, the ledge can also be designed as an elastic element, for example comprising silicon or rubber, and can be designed so as to be deformable.

According to one embodiment, the storage cabinet comprises a net mass of at least 30 kg and is designed to accommodate a load with a mass in excess of about 100 kg. For example, the storage cabinet can comprise a net mass of between about 30 kg and about 60 kg and can be designed to accommodate a load in excess of about 300 kg.

According to one embodiment of the present disclosure, the body comprises a width of at least 610 mm and at most 1067 mm. In one example, the body comprises, for example, a width of between about 630 mm and about 765 mm. Furthermore, the body can comprise a depth of at least 800 mm, in one example of at least 900 mm.

According to one embodiment, the body comprises a convex rear wall. In other words, the rear wall of the body can be curved towards an outside of the storage cabinet. In this arrangement a contour of the rear wall can, for example, match a contour of an outer skin of the means of transport so that it is possible that there are no spaces between the body and the outer skin.

According to one embodiment of the present disclosure, the rear wall comprises a rubber lip that is designed to rest against an outer skin of the means of transport. In this arrangement the rubber lip can be designed so as to be approximately circumferential on the rear wall, or only in a partial region of the rear wall. For example, the rubber lip can be arranged on a lateral and/or a top partition wall of the body and can project from said wall so that the rear of the storage cabinet or the rear wall can be sealed off from an environment of the storage cabinet. The rubber lip can be designed so as to prevent, at the rear, any objects from reaching the space between the storage cabinet and the outer skin.

According to one embodiment, at least one catering trolley on rollers can be accommodated in the storage cabinet. In this arrangement the storage cabinet in the floor region comprises at least one guide rail for guiding the catering trolley and at least one ramp for easier sliding of the catering trolley into the storage cabinet.

In this arrangement the guide rail can project from a sidewall of the storage cabinet in the floor region to an interior of the storage cabinet, for example in the form of a spacer, so that rollers of the catering trolley cannot jam during sliding-in and sliding-out, because said rollers can be guided by the guide rail and can be adequately spaced apart from the sidewall.

According to the various teachings of the present disclosure, provided is an aircraft comprising a storage cabinet as described above and below.

According to one embodiment of the present disclosure, the body of the storage cabinet comprises a top edge, which is spaced apart from the cabin element by at least 50 mm, in one example, by at least 60 mm, so that a surface of a top partition wall of the body, which surface faces the cabin element, can be accessed from the outside and can be used as a storage surface. In this context the term “top edge” can denote a top contour of the storage cabinet. The top edge can, for example, be defined by the contour of the top partition wall or by an outside surface of the top partition wall.

In this context the space from the cabin element can be dimensioned as the space between the top edge of the storage cabinet and a bottom limiting surface of the cabin element, which bottom limiting surface is directed towards the bottom of the passenger cabin.

The storage cabinet can thus be dimensioned in such a manner that during installation or deinstallation of the storage cabinet in the aircraft between the top edge and the cabin element there is a gap or a space of at least 50 mm. On the one hand a space can make it possible for the storage cabinet to be lifted for undoing the attachment device from the floor attachment elements, and on the other hand this can make it possible for the top partition wall to be used as a further storage surface or as a storage shelf. The storage surface can, for example, be used to temporarily store utility objects, for example documents, journals or newspapers.

According to one embodiment, the storage surface comprises a non-slip surface and a ledge rising towards the cabin element, which ledge is designed to delimit the storage surface laterally and towards the rear of the storage cabinet. The surface can, for example, be rubberized or be roughened so as to be of a non-slip nature.

The ledge can be designed to prevent lateral and rearwards sliding, or falling, of objects stored on the storage surface. Furthermore, the ledge can define the top edge or the top contour of the storage cabinet, which top edge during installation and deinstallation of the storage cabinet can be spaced apart by at least 50 mm, and in one example, by at least 60 mm, from the cabin element.

As described above, the ledge of the storage cabinet can also, for example, be designed as pivotable or as an elastic element. In such an embodiment the top edge of the storage cabinet can designate a top edge with the ledge pivoted-in or deformed. In this manner it is possible to ensure, during installation or deinstallation, that there is a space or gap of at least 50 mm between the storage cabinet and the lower limiting surface of the cabin element, which delimiting surface faces the passenger cabin. This can, for example, make it possible to attach or detach the attachment device of the storage cabinet from the floor attachment elements. In the actual installed state of the storage cabinet, in which state said storage cabinet can be attached in the passenger cabin, the ledge can be pivoted up again, i.e. it can project upwards from the storage surface, and it can be flush with the bottom limiting surface of the cabin element. In the case of the ledge being designed as an elastic element, in its installed state the ledge can also rest against the cabin element so as to be slightly deformed or not deformed.

According to one embodiment, for the purpose of expanding storage space in a galley module, the storage cabinet is attached in the aircraft in the location of a seat row after said seat row has been deinstalled. In other words the storage cabinet can be designed to be installed instead of a seat row, wherein the term “seat row” can, for example, refer to an individual seat, a two-seat row, or a three-seat row. Overall, this can make it possible to achieve a flexible design of the interior equipment of the aircraft and thus also flexible use of the aircraft. For example, for short-haul flights it is possible to provide an additional seat row for passengers, whereas for long-haul flights it can be advantageous to install the storage cabinet instead of the seat row in order to provide additional storage space, for example for catering trolleys and galley equipment. Because of the advantageous design of the storage cabinet it is possible to implement reconfiguration within the aircraft's turnaround time between two consecutive flights. This turnaround time can, for example, be 15 to 30 minutes, typically approximately 20 minutes.

According to one embodiment of the present disclosure, the corresponding floor attachment elements of the passenger cabin comprise at least one seat rail and/or at least one hard point of the aircraft.

The attachment device of the storage cabinet can thus be designed to be attached to a seat rail or to a hard point of the aircraft. In this context the term “hard point” can refer to an affixation device for detachably affixing interior equipment of the aircraft, wherein hard points can be affixed to cross members and/or to longitudinal members of a floor grid of the aircraft.

According to one embodiment, the storage cabinet comprises adequately small dimensions for it to be removed, in the fully equipped state of the passenger cabin, from the aircraft in one piece through an external door of the passenger cabin.

According to one embodiment of the present disclosure, the storage cabinet comprises adequately small dimensions for it to be removed from the aircraft in one piece through an external door of the passenger cabin, wherein the external door comprises a maximum width of about 1067 mm.

The storage cabinet can thus be installed in the aircraft in a short period of time, for example the turnaround time, without this requiring deinstallation and/or deformation of further elements or modules of the interior equipment or of parts of the storage cabinet. It may merely be necessary to undo a cover of a floor region of the aircraft so that the floor attachment elements are accessible and the attachment elements of the storage cabinet can be attached to said attachment elements.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 diagrammatically shows a front view of a storage cabinet according to one exemplary embodiment of the present disclosure.

FIG. 2 diagrammatically shows a cross section along the line A-A of the storage cabinet of FIG. 1.

FIG. 3 diagrammatically shows a perspective view of a storage cabinet according to one exemplary embodiment of the present disclosure.

FIG. 4 diagrammatically shows a perspective view of a storage cabinet according to one exemplary embodiment of the present disclosure.

FIG. 5 diagrammatically shows a storage cabinet according to one exemplary embodiment of the present disclosure in a passenger cabin of an aircraft.

FIG. 6 diagrammatically shows a storage cabinet according to one exemplary embodiment of the present disclosure in a passenger cabin of an aircraft.

FIG. 7 diagrammatically shows a storage cabinet according to one exemplary embodiment of the present disclosure in a passenger cabin of an aircraft.

FIG. 8 shows an aircraft comprising a storage cabinet according to one exemplary embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

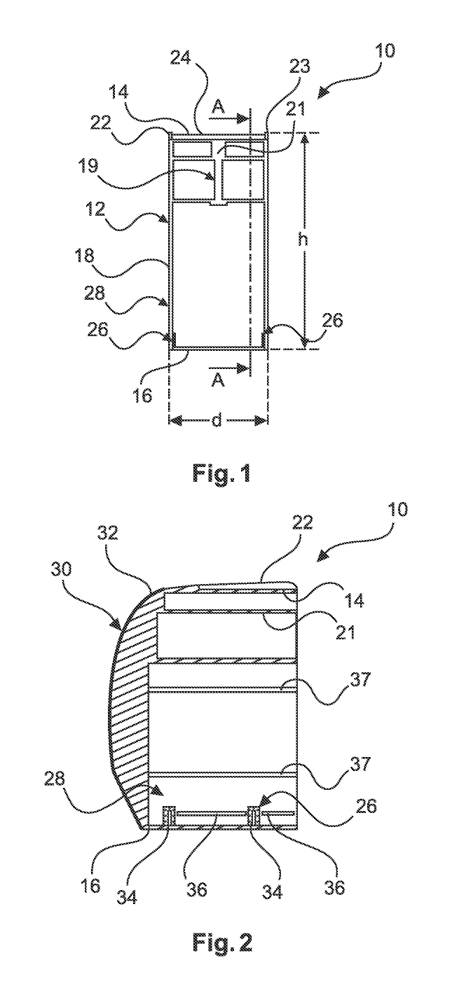

FIG. 1 diagrammatically shows a front view of a storage cabinet 10 according to one exemplary embodiment of the present disclosure.

The storage cabinet 10 comprises a body 12 of a height h of at least 140 cm and a width d of at least 61 cm and at most 106.7 cm. In one example, the body comprises a width d between, for example, about 63 cm and about 76.5 cm. The body 12 in turn comprises a top partition wall 14 and a bottom partition wall 16 as well as sidewalls 18.

Furthermore, in the body 12 a structuring device 19 is arranged that comprises elements 21 that extend so as to be orthogonal and parallel to the top and bottom partition walls 14, 16, which elements 21 can be used for structuring or partitioning the interior space of the storage cabinet 10 into several regions.

From the top partition wall 14, a ledge 22 projects upwards both laterally and at the rear so that on a surface of the top partition wall 14, which surface faces an outside, a storage surface 24 is delimited laterally and towards the rear of the storage cabinet 10. In this arrangement the ledge 22 defines a top edge 23, from which the height h of the storage cabinet 10 can be determined.

On the interior of the body 12 an attachment device 26 is arranged in a floor region 28 of the storage cabinet 10. The attachment device 26 is designed for detachably attaching the storage cabinet 10 to corresponding floor attachment elements, for example in a means of transport.

FIG. 2 diagrammatically shows a cross section along the line A-A of the storage cabinet 10 of FIG. 1 with the direction of view to the inside of the sidewall 18.

The cross section of FIG. 2 clearly shows that the storage cabinet 10 comprises a convex rear wall 30 that is curved to an outside of the storage cabinet 10. A rubber lip 32 is arranged laterally on the rear wall 30, i.e. in a region in which the sidewall 18 extends, which rubber lip 32 is designed to rest against an outer skin of the means of transport. In this arrangement the rubber lip 32 projects symmetrically from the two lateral delimitations of the rear wall 30 from said rear wall 30. Furthermore, a rubber lip 32 can be arranged at the height of the top partition wall 14 and of the bottom partition wall 16.

As shown in FIG. 2, in the floor region 28 on a sidewall 18 the attachment device 26 comprises two attachment elements 34. In this arrangement the attachment elements 34 are arranged symmetrically on both sidewalls 18 and/or on the bottom partition wall 16, and, for attachment, are designed to engage corresponding floor attachment elements of the means of transport so that the storage cabinet 10 can be detachably attached with the use of the attachment elements 34.

Furthermore, in a floor region in the interior of the body 12 a guide rail 36 is arranged that can be designed so as to project from the sidewall 18. In this arrangement the guide rail 36 can be arranged in the interior on both sidewalls 18 and can be designed to space apart items of equipment, for example a catering trolley 46 on rollers (see FIG. 6), from the sidewall 18. Furthermore, on the sidewalls in the interior of the body 12 protective ledges 37 are arranged that can be designed to absorb shocks and vibrations from equipment accommodated in the storage cabinet 10, and to protect the sidewalls.

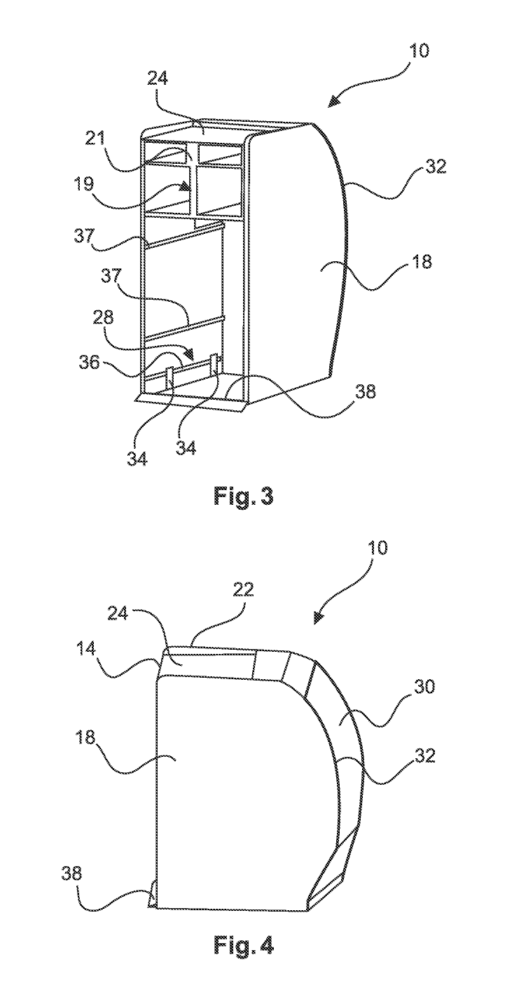

FIG. 3 diagrammatically shows a perspective view of a storage cabinet 10 according to one exemplary embodiment of the present disclosure. Unless otherwise stated, the storage cabinet 10 of FIG. 3 comprises identical elements and characteristics to those of the storage cabinet of FIGS. 1 and 2.

In the floor region 28 at the front the storage cabinet 10 of FIG. 3 comprises a ramp 38 that is arranged so as to be flush with the bottom partition wall 16 and that comprises a gradient angle of at most 16°. The ramp 38 can, for example, be designed to facilitate sliding-in and sliding-out a catering trolley 46 on rollers (see FIG. 6).

Furthermore, the perspective view of FIG. 3 clearly shows the storage surface 24 delimited by the ledge 22, which storage surface can be used, for example, for storing documents, journals or newspapers. To this effect the storage surface 24 comprises a non-slip surface, for example a surface coated with rubber or silicon.

FIG. 4 diagrammatically shows a perspective view of a storage cabinet 10 according to an exemplary embodiment of the present disclosure. Unless otherwise stated, the storage cabinet 10 of FIG. 4 comprises elements and characteristics that are identical to those of the storage cabinets 10 shown in FIGS. 1 to 3. FIG. 4 clearly shows the convex rear wall 30 with the rubber lip 32 arranged laterally and in the upper region of the storage cabinet 10.

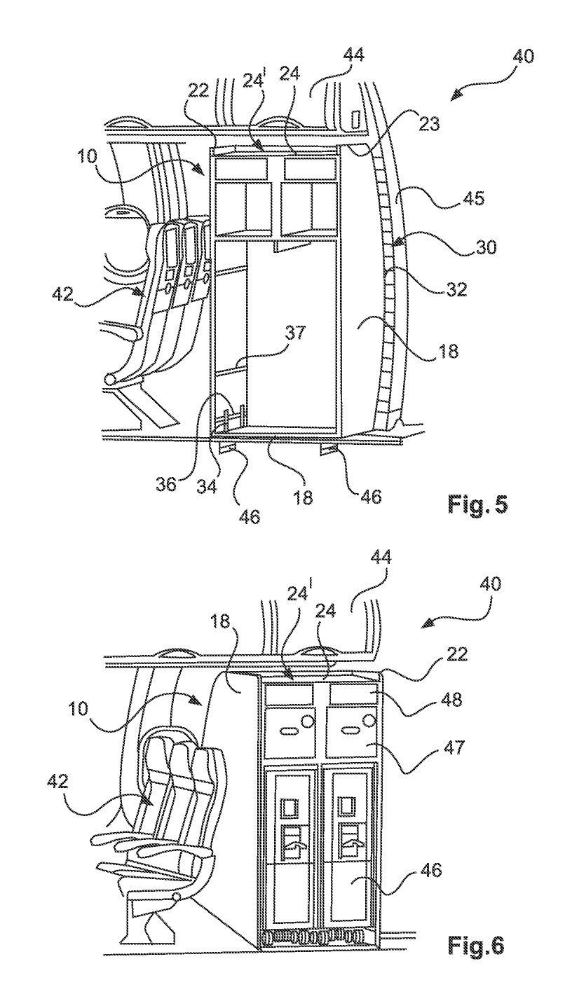

FIG. 5 diagrammatically shows a storage cabinet 10 in a passenger cabin 40 of an aircraft 100 (see FIG. 8). Unless otherwise stated, the storage cabinet 10 of FIG. 5 shows elements and characteristics that are identical to those of the storage cabinets 10 of FIGS. 1 to 4.

FIG. 5 shows a section of the passenger cabin 40 with a seat row 42 of three passenger seats and a hatrack 44. In this arrangement the storage cabinet 10 is detachably attached, underneath the hatrack 44, by way of the attachment elements 34, to corresponding floor attachment elements 46 of the aircraft 100. The floor attachment elements 46 can, for example, comprise a seat rail and/or a hard point of the aircraft 100.

For undoing the attachment of the storage cabinet 10 from the floor attachment elements the storage cabinet 10 is arranged under the hatrack 44 so that said storage cabinet 10 can be lifted. In other words, for the purpose of undoing the attachment from the corresponding floor attachment elements 46 the storage cabinet is designed to be lifted. To this effect a top edge 23 of the storage cabinet 10, which can be defined by the ledge 22 on the storage surface 24, is spaced apart from the hatrack 44 by at least 50 mm, for example by at least 60 mm, so that for the purpose of undoing the attachment the storage cabinet 10 can easily be lifted, for example by a worker, by at least 5 mm, for example by at least 7 mm or, for example by at least 10 mm.

Furthermore, as a result of the spacing from the hatrack 44 the storage surface 24 can be used for storing objects such as newspapers. Thus a storage shelf 24′ can be formed that is delimited laterally and towards an outer skin 45 of the aircraft 100 by the ledge 22, towards the top by the hatrack 44, and downwards by the top partition wall 14 of the body 12. The storage shelf 24′ is thus accessible from the front of the storage cabinet 10 and can be used as additional storage space.

Furthermore, a curvature of the rear wall 30 of the storage cabinet 10 is designed so as to match a curvature of the outer skin 45 of the aircraft 100 so that the rubber lip 32 rests against the outer skin 30 so as to provide a seal, and so that at the rear no objects can be pushed between the storage cabinet 10 and the outer skin 45 or can slide behind the storage cabinet 10.

FIG. 6 diagrammatically shows a further storage cabinet 10 in a passenger cabin 40 of an aircraft 100. Unless otherwise stated, the storage cabinet 10 of FIG. 6 comprises identical elements and characteristics to those of the storage cabinets 10 of FIGS. 1 to 5.

FIG. 6 shows the storage cabinet 10 in a laden state, wherein the storage cabinet 10 accommodates two catering trolleys 46 on rollers side by side, at least two standard drawers 47, and at least two standard units of galley equipment. In a fully laden state the storage cabinet 10 including its net mass can thus comprise a mass in excess of about 300 kg.

The storage cabinet can thus be used to expand the storage space of a galley module, wherein after deinstallation of a seat row 42 in the aircraft 100, in one example, in the tail region of the aircraft 100, the storage cabinet 10 can be attached at the location of the seat row 42.

As a result of the advantageous design of the storage cabinet 10 with an attachment device 26 that can quickly be unlocked and locked, and with an external dimension of the storage cabinet 10 that allows quick undoing of the attachment by means of lifting the storage cabinet 10, the storage cabinet can be installed in the aircraft 100, for example, in the turnaround period between two flights. In this process it is only necessary to remove one seat row 42 and, if applicable, one cover from the floor attachment elements 46. There is no need to deinstall any further equipment in the passenger cabin 40 or any parts of the storage cabinet 10 itself.

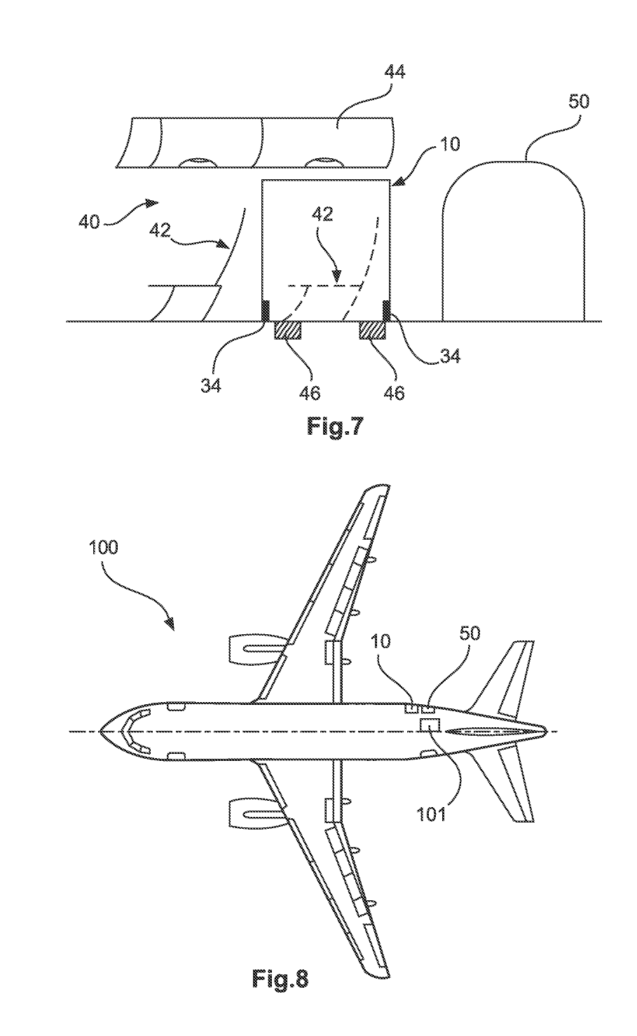

FIG. 7 diagrammatically shows a further storage cabinet 10 in a passenger cabin 40 of an aircraft 100. Unless otherwise stated, the storage cabinet 10 of FIG. 7 comprises identical elements and characteristics to those of the storage cabinets 10 of FIGS. 1 to 6.

The storage cabinet 10 of FIG. 7 is attached, by means of the attachment device 26, to corresponding floor attachment elements 46 of the passenger cabin 40. The floor attachment elements 46 can, for example, comprise a seat rail or at least one hard point of the aircraft 100.

In this arrangement the storage cabinet 10 is arranged in the aircraft 100 after deinstallation of a seat row 42 in the location previously taken up by the seat row 42. This is indicated by the dashed line of the seat row 42 shown in the storage cabinet 10.

Furthermore, the storage cabinet 10 comprises adequately small dimensions for it to be removed, in the fully equipped state of the passenger cabin 40, from the aircraft 100 in one piece through an external door 50 of the passenger cabin 40. In this arrangement the external door 50 comprises a maximum width of 1067 mm.

FIG. 8 shows an aircraft comprising a storage cabinet 10 and a galley module 101. In this arrangement the storage cabinet 10 is arranged in the tail region of the aircraft 100 in order to expand the available storage space of the galley module 101.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A storage cabinet for a passenger cabin of a means of transport for storing equipment, with the storage cabinet comprising:
a body having a height of at least 140 cm;
a floor region; and
only one attachment device,
wherein the attachment device is arranged in the floor region of the storage cabinet and is configured to detachably attach the storage cabinet to corresponding floor attachment elements in the passenger cabin underneath a cabin element of the passenger cabin.

2. The storage cabinet of claim 1,
wherein the attachment device is configured to undo the attachment of the storage cabinet from the corresponding floor attachment elements of the passenger cabin by lifting.

3. The storage cabinet of claim 1,
wherein the attachment device comprises at least four attachment elements that are configured to attach the storage cabinet to the corresponding floor attachment elements in the passenger cabin.

4. The storage cabinet of claim 1,
wherein the storage cabinet comprises a top partition wall having a surface, with the surface of the top partition wall facing an outside of the storage cabinet to be used as a storage surface.

5. The storage cabinet of claim 1,
wherein the storage cabinet comprises a net mass of at least 30 kg and is configured to accommodate a load with a mass in excess of 100 kg.

6. The storage cabinet of claim 1,
wherein the body comprises a width of at most 1067 mm.

7. The storage cabinet of claim 1,
wherein the body comprises a convex rear wall.

8. The storage cabinet of claim 7,
wherein the rear wall comprises a rubber lip that is configured to rest against an outer skin of the means of transport.

9. The storage cabinet of claim 1,
wherein at least one catering trolley on rollers is receivable in the storage cabinet, and the storage cabinet comprises at least one guide rail in the floor region for guiding the at least one catering trolley and at least one ramp for easier sliding of the at least one catering trolley into the storage cabinet.

10. An aircraft, comprising:
a passenger cabin including a cabin element, the passenger cabin having a floor attachment element;
a storage cabinet including a body having a height of at least 140 cm, a floor region and an attachment device arranged in the floor region of the storage cabinet,
wherein the attachment device detachably attaches the storage cabinet to the floor attachment element in the passenger cabin underneath the cabin element.

11. The aircraft of claim 10,
wherein the body of the storage cabinet comprises a top edge, which is spaced apart from the cabin element by at least 50 mm, so that a surface of a top partition wall that faces the cabin element is accessible from an outside of the storage cabinet for use as a storage surface.

12. The aircraft of claim 11,
wherein the storage surface comprises a non-slip surface and a ledge rising towards the cabin element, which ledge is designed to delimit the storage surface laterally and towards a rear of the storage cabinet.

13. The aircraft of claim 10,
wherein the storage cabinet is attached in the passenger cabin of the aircraft in a location of a seat row after said seat row has been removed.

14. The aircraft of claim 10,
wherein the floor attachment element of the passenger cabin comprise at least one of a seat rail and a hard point of the aircraft.

15. The aircraft of claim 10,
wherein the storage cabinet is removable, in the fully equipped state of the passenger cabin, from the aircraft in one piece through an external door of the passenger cabin.

16. The storage cabinet of claim 4,
wherein on the storage surface a ledge is arranged that projects upwards towards the outside of the storage cabinet, which ledge is designed to delimit the storage surface laterally and towards a rear of the storage cabinet.

17. The aircraft of claim 10,
wherein the body of the storage cabinet comprises a convex rear wall.

18. The aircraft of claim 17,
wherein the rear wall comprises a rubber lip that is configured to rest against an outer skin of the aircraft.

19. The aircraft of claim 10,
wherein the attachment device of the storage cabinet is configured to undo the attachment of the storage cabinet from the floor attachment element of the passenger cabin by lifting.

20. The aircraft of claim 10,
wherein at least one catering trolley on rollers is receivable in the storage cabinet, and the storage cabinet comprises at least one guide rail in the floor region for guiding at least one catering trolley into the storage cabinet and at least one ramp for easier sliding of the at least one catering trolley into the storage cabinet.
